(19) United States
(12) Patent Application Publication
(10) Pub. No.: US 2009/0158181 A1
(43) Pub. Date: Jun. 18, 2009

(54) USER INTERFACE METHOD AND APPARATUS TO NAVIGATE A DOCUMENT FILE

(75) Inventors: Santiago Becerra, SR., Del Mar, CA (US); Quinton Alsbury, Venice, CA (US); Jaime Zuluaga, Fremont, CA (US); David Becerra, Marina del Rey, CA (US); Claire B. Maytum, San Diego, CA (US)

Correspondence Address: SAN FRANCISCO OFFICE OF;NOVAK, DRUCE & QUIGG LLP, 1000 LOUISIANA STREET, FIFTY-THIRD FLOOR, HOUSTON, TX, 77002, US

(73) Assignee: MELLMO LLC, San Diego, CA (US)

(21) Appl. No.: 12/105,972

(22) Filed: Apr. 18, 2008

Related U.S. Application Data
(60) Provisional application No. 61/014,606, filed on Dec. 18, 2007.

(51) Int. Cl. G06F 3/048; G06F 7/00; G06F 17/30

(52) U.S. Cl. 715/764; 707/3; 707/E17.014

(57) ABSTRACT

A method is provided to produce a visual interface to an electronic device comprising: displaying a first region of a document superimposed with a context map within a display window; displaying a position marker within the context map at a first position relative to the context map; wherein the context map has dimensions that are substantially proportionate to dimensions of the document; wherein the first region of the document is disposed at a first position relative to the document that is substantially the same as the first position of the position marker relative to the context map; displaying a change of the position marker from the first position to a second position within the context map; and displaying in response to the change of the position marker to the second position, a second region of the document is displayed that is disposed at a second position relative to the document that is substantially the same as the second position of the position marker relative to the context map.

### CROSS-REFERENCE TO RELATED APPLICATION

This application claim priority to U.S., Provisional Patent Application Ser. No. 61/014,606, filed Dec. 18, 2007, entitled “FILE NAVIGATION OVERLAY,” which is expressly incorporated herein by this reference.

### BACKGROUND OF THE INVENTION

1. Field of the Invention

The invention relates in general to computer user interfaces, and more particularly, to user interfaces to search for information within a document file.

2. Description of the Related Art

FIGS. 1A-1B are illustrative drawings of a spreadsheet (FIG. 1A) and a pivot table (FIG. 1B) that are too large to be viewed all at once within the confines of a typical screen display. A graphical user interface (GUI) to a spreadsheet or pivot table application ordinarily includes vertical and horizontal scroll bars to achieve horizontal and vertical navigation through the document. Since, a spreadsheet or a pivot table may be too large to display all at once on a computer screen display, a user scrolls horizontally and vertically to navigate to portions of the document that are outside of the screen display.

FIG. 2 is an illustrative drawing showing exploration of a page of a form document using a known pan and zoom user interface tool. The example form includes information arranged in rows and columns. A rectangular boundary overlaid on the form indicates a user-selected portion of the form. The selected portion of the form within the boundary is shown enlarged behind a smaller scale image of a full page of the form. In operation, a user may toggle back and forth between the image of the entire page of the form and the enlarged image of a portion of that page. Although the form may be part of a larger multi-page document, the pan and zoom tool operates only on a currently displayed page of the document. In order to pan and zoom on other portions of the document not currently displayed on-screen, a user must first navigate to a page of the document that contains the portion of interest, and then use the pan and zoom tool to take a closer look at it.

FIG. 3A is an illustrative drawing showing exploration of a digital photo image using a known pan and zoom user interface tool. A small-scale image of an entire photo is shown on a lower right side of the screen display adjacent an enlarged portion of the image. In the illustrated example, an upper portion of the small-scale image is highlighted. A large-scale (zoomed) image of the highlighted portion of the small-scale image is shown within the main screen display. A user highlights a portion of the small-scale image to indicate the portion of the image to enlarge.

FIG. 3B is an illustrative drawing showing a digital camera with wheel knobs to allow pan and zoom within the digital picture display area.

While prior user interfaces to documents generally have been acceptable, there have been shortcomings with their use. For example, there has been a need for improvements to techniques to navigate larger documents that cannot be fit all at once within a display screen. This need is even greater in small screen devices such as mobile phones that have limited screen area in which to show user interface tools used to indicate a portion of a document that is of interest. Moreover, there has been a need for more flexible movement through documents such as a spreadsheet in which rows and columns delimit information. The present invention meets these needs.

### SUMMARY OF THE INVENTION

In one aspect, a method is provided to produce a visual interface to an electronic device. The method involves displaying a context map superimposed with a first region of a document within a display window. A position marker is displayed within the context map at a first position relative to the context map. The context map has dimensions that are substantially proportionate to dimensions of the document, and the first region of the document is disposed at a first position relative to the document that is substantially the same as the first position of the position marker relative to the context map. A change of the position marker from the first position to a second position within the context map is displayed within the display window. In response to the change of the position marker to the second position, a second region of the document is displayed that is disposed at a second position relative to the document that is substantially the same as the second position of the position marker relative to the context map.

Thus, the context map and the position marker serve as navigation aids. The context map indicates overall document landscape. The position marker indicates the location of a region of a document that is currently in view relative to the overall document landscape. Together, the context map and the position marker provide a user with context within which to understand the relationship of the region of a document currently displayed to the overall document. Since the context map and the position marker are superimposed with the region currently in view, screen area is not sacrificed by the addition of these navigation aids. Moreover, in some embodiments, the user can view the entire region currently displayed, even though it is superimposed with the overlay while simultaneously viewing context information provided by the map and the position marker, which can be helpful in navigating other parts of the document.

In another aspect, user input is received by the device to indicate a search request for information within the document. In response, match markers are displayed within the display window within the context map that correspond to positions within the document that include information responsive to the search request. Each respective match marker is disposed at a position relative to the context map that is substantially the same as a respective corresponding position relative to the document at which information responsive to the search request is located within the document.

Therefore, the context map annotated with match markers provides a compact yet comprehensive visual representation of the location of search results within the document. Based on the locations of the match markers within the context map, the user knows which way to move the position marker to view search results. The user can choose to move the position marker to any of the search locations to view details surrounding the results, for example.

These and other features and advantages of the invention will be apparent to persons skilled in the art from the following detailed description of embodiments thereof in conjunction with the appended drawings.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIGS. 1A-1B are illustrative drawings of a spreadsheet (FIG. 1A) and a pivot table (FIG. 1B) that are too large to be viewed all at once within the confines of a typical screen display.

FIG. 2 is an illustrative drawing showing exploration of a page of a form document using a known pan and zoom user interface tool.

FIGS. 3A-3B are illustrative drawings showing exploration of a digital photo image using a known pan and zoom user interface tool (FIG. 3A) and a digital camera with wheel knobs to allow pan and zoom within the digital picture display area (FIG. 3B).

FIG. 4 is an illustrative drawing showing example dimensional and positional relationships among a document, a display window, a context map and a viewing position marker in accordance with some embodiments of the invention.

FIG. 5 is an illustrative drawing showing an entire document and also showing a display window that displays a first region of the document in accordance with some embodiments of the invention.

FIG. 6 is an illustrative drawing showing the document and display window of FIG. 5 and also showing a context map within the display window in accordance with some embodiments of the invention.

FIG. 7 is an illustrative drawing showing the document and display window and context map of FIG. 6 and also showing a viewing position marker within the context map in accordance with some embodiments of the invention.

FIG. 8 is an illustrative drawing representing a transition from a display of a first region of the document of FIG. 7 within the device display to a display of a second region of the document within the device display in accordance with some embodiments of the invention.

FIG. 9 is an illustrative drawing showing the document, display window, context map and marker of FIG. 8 and also showing search request match locations within the context map in accordance with some embodiments of the invention.

FIG. 10 is an illustrative drawing showing the document and the display window displaying the same second region that is shown in FIG. 9, but without the context map and position marker.

FIG. 11 is an illustrative flow diagram of a process to navigate through a document in accordance with some embodiments of the invention.

FIGS. 12A-12B is an illustrative flow diagram representing process 1 of FIG. 11 in accordance with some embodiments of the invention.

FIG. 13 is an illustrative flow diagram representing process 2 of FIG. 11 in accordance with some embodiments of the invention.

FIG. 14 is an illustrative flow diagram representing process 3 of FIG. 11 in accordance with some embodiments of the invention.

FIG. 15 is an illustrative flow diagram representing process 4 of FIG. 11 in accordance with some embodiments of the invention.

FIG. 16 is an illustrative drawing displaying 100% zoom level for the original document in accordance with some embodiments of the invention.

FIG. 17 is an illustrative drawing displaying 175% zoom level for the original document in accordance with some embodiments of the invention.

FIG. 18 is an illustrative drawing showing dimensions of document, display window, context map and position marker used by process 1 to determine context map area and position marker area in accordance with some embodiments of the invention.

FIG. 19 is an illustrative drawing showing dimensions of document, display window, context map and position marker used by process 1 to determine initial document position in accordance with some embodiments of the invention.

FIG. 20 is an illustrative drawing showing width and dimensions of document, display window, context map and position marker used by process 2 in the course of movement of the position marker to a different (second) position and the transition of the display window to a different (second) region in accordance with some embodiments of the invention.

FIG. 21 is an illustrative drawing representing position marker transition in a smooth animation along a path from a first position “A” to a second position “B” within the context map using process 2 in accordance with some embodiments of the invention.

FIG. 22 is an illustrative drawing representing identification and display of match markers in response to a user search request using process 3 in accordance with some embodiments of the invention.

FIG. 23 is an illustrative block level diagram of a processing system that can be programmed to implement processes involved with navigating a document in accordance with embodiments of the invention.

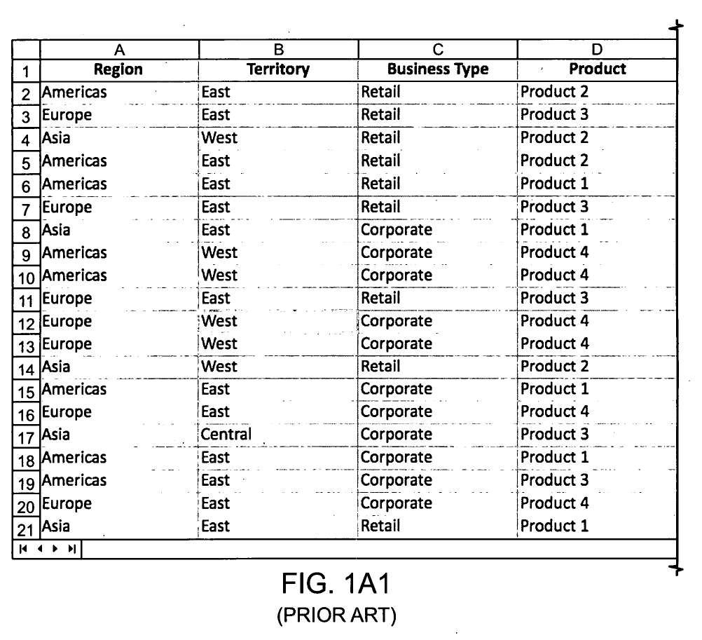

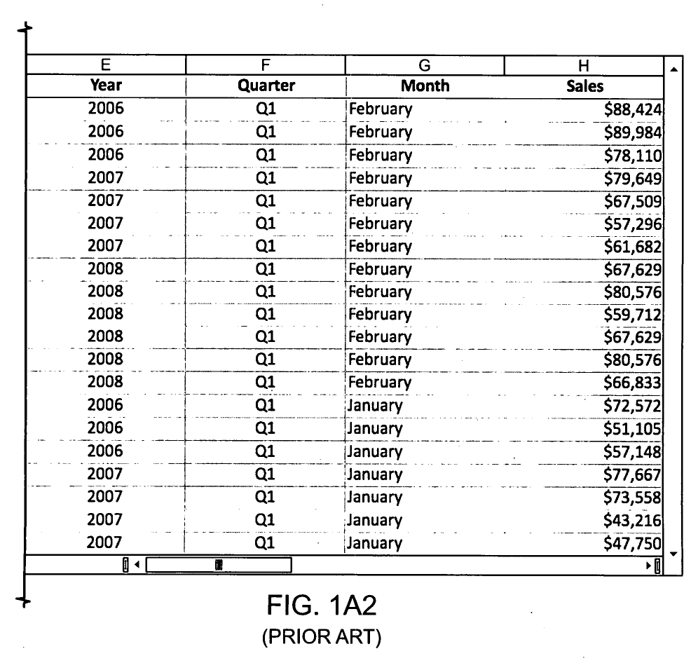

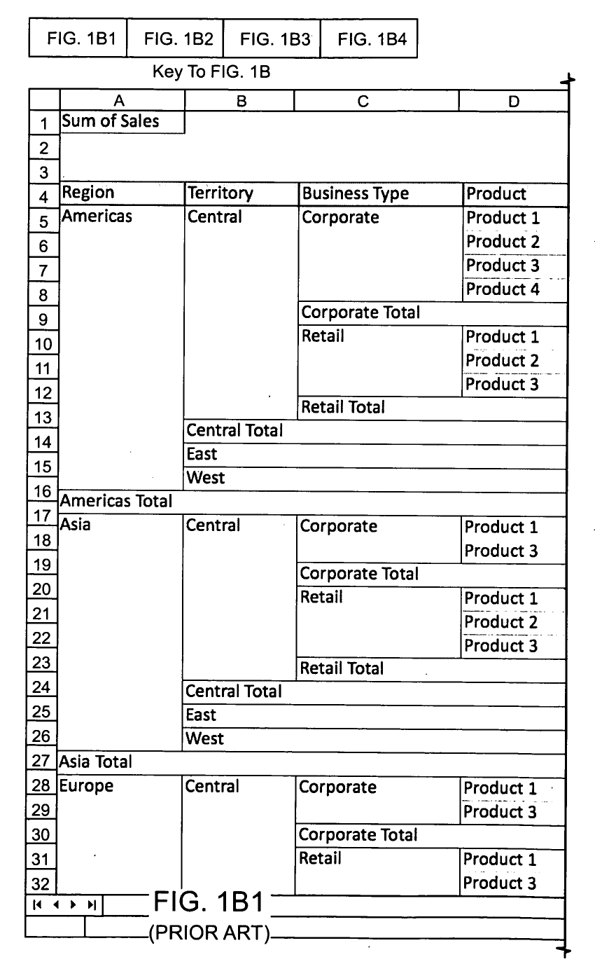

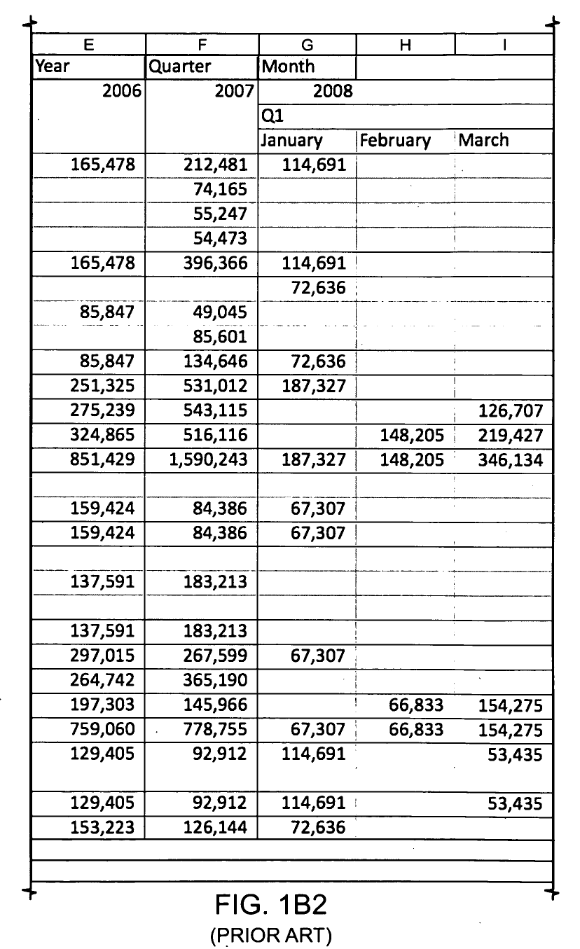

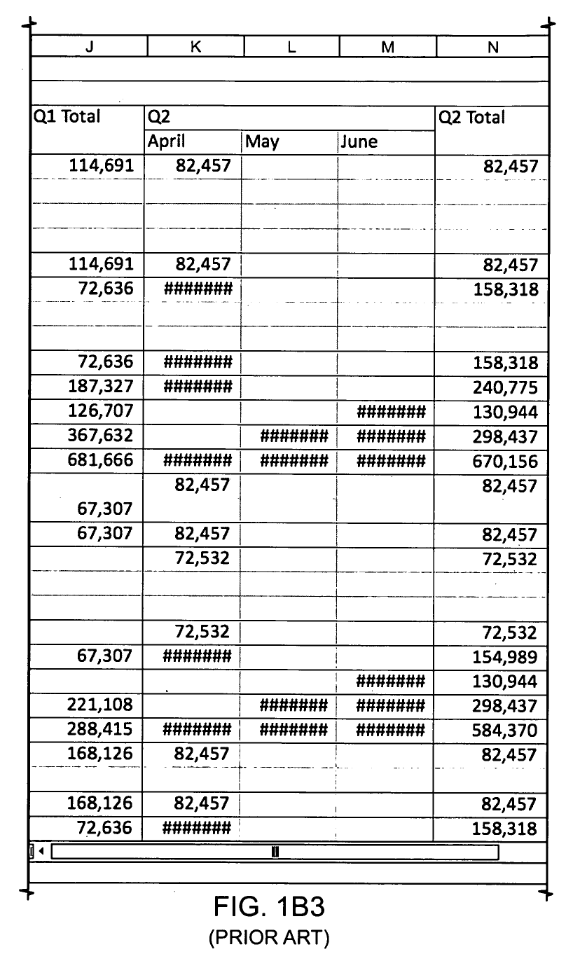

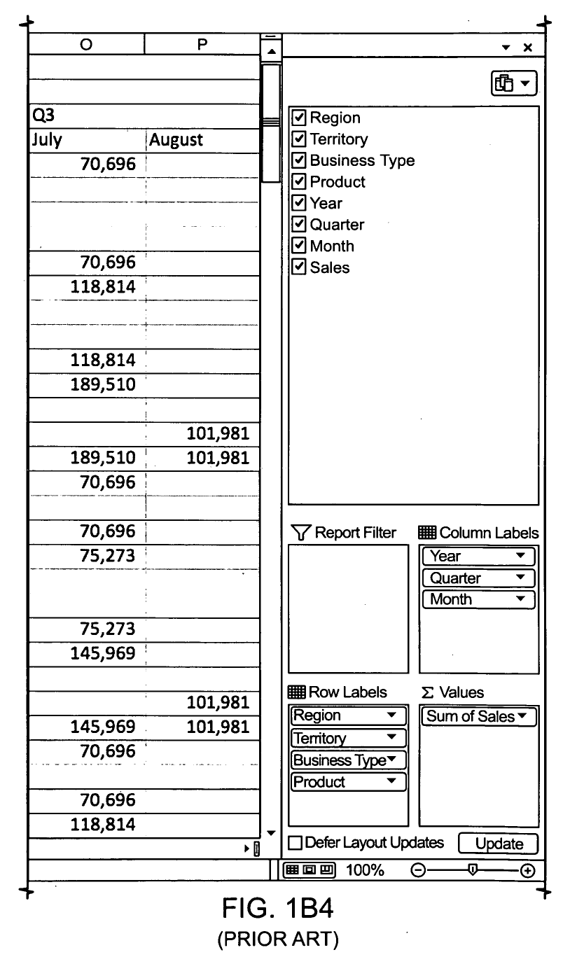

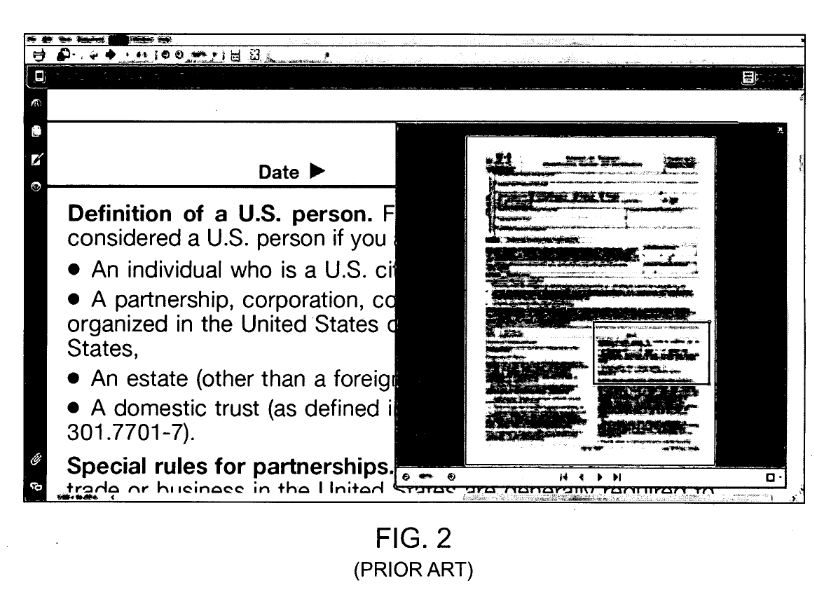

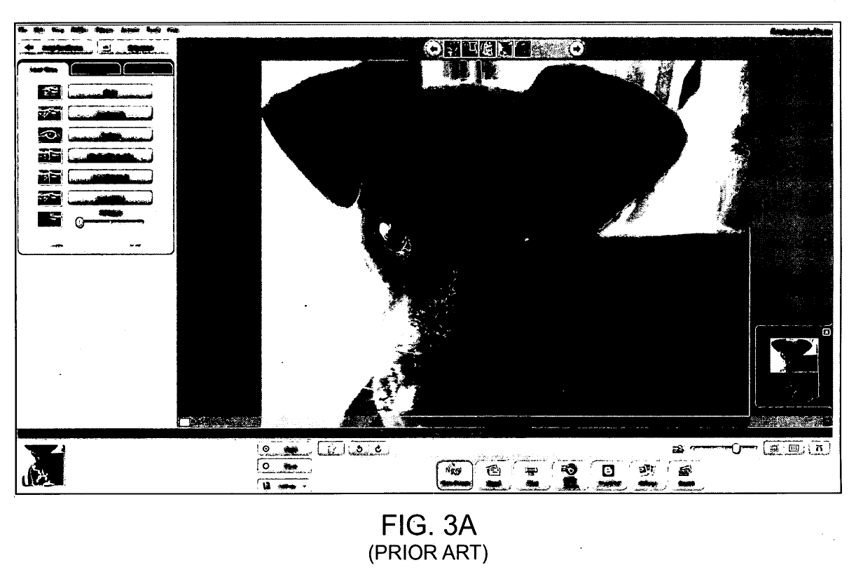

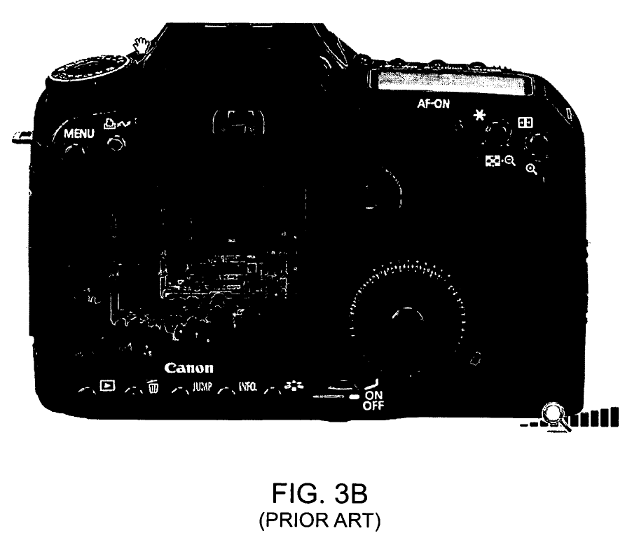

### DETAILED DESCRIPTION OF THE PREFERRED EMBODIMENTS

The following description is presented to enable any person skilled in the art to make and use a method and apparatus to navigate a document, in accordance with embodiments of the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

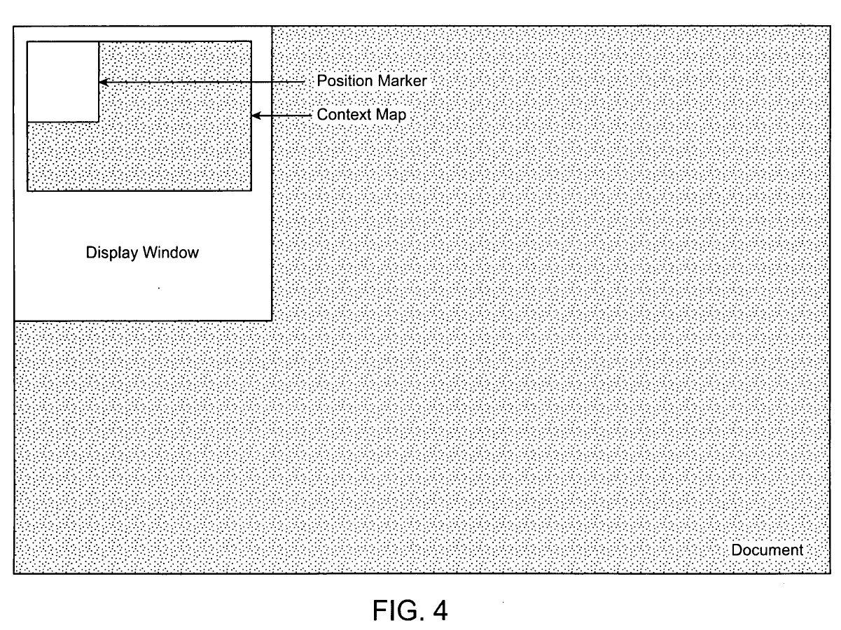

FIG. 4 is an illustrative drawing showing example dimensional and positional relationships among a document, a display window, a context map and a viewing position marker in accordance with some embodiments of the invention. The document is shown to have dimensions that are larger than the dimensions of the display window. Consequently, only a portion of the entire document is visible within the display window at any given time. The context map, sometimes referred to as a navigation map, is displayed within the display window and has dimensions that are proportionate to the dimensions of the document. The position marker, sometimes referred to as a scroll marker, is disposed within the context map and has dimensions that are proportionate to the dimensions of the display window. The relative dimensions of the marker to the context map are substantially the same as the relative dimensions of the display window to the overall document.

Moreover, FIG. 4 shows an example positional relationship between a region of the document viewable within the display window and other regions of the document. FIG. 4 also shows a corresponding example positional relationship between the context map displayed within the display window and the position marker displayed within the context map. In particular, an upper left region of the document is shown to be displayed within the display window, and the position marker is shown to be positioned within an upper left region of the context map. The position of the region of the document displayed within the display window relative to the overall document is the same as the relative position of the position marker within the context map relative to the overall context map.

As used herein, a document refers to an electronic file such as a spreadsheet, tabular report, text report, form, chart or map, for example. Dimensions of a document indicate physical document size. Document dimensions can be indicated in terms of number of pixels. Alternatively, for a document that comprises an intangible electronic or computer generated image such as a virtual game play area or map in a video game, for example, the dimensions can be set by the document creator.

As explained more fully below, the context map and position marker can be used to navigate a document that has dimensions that exceed the available area of a display screen of a device such as a personal computer, tablet computer, smart mobile device or mobile phone, camera, for example. The device produces what shall be referred to herein as a ‘window’, which comprises a visual image displayed using the device screen. For instance, a visual image such as an image that includes a region of the document, the context map and the position marker, can be displayed using display screen pixels.

The context map and the viewing position marker cooperate to indicate the position within the document of the document region currently displayed within the display window. The overall shape of the context map is substantially the same as the overall shape of the document, and the position of the position marker within the context map corresponds to the position of the displayed region of the document within the overall document. Accordingly, the context map in combination with the viewing position marker provide a visual context in which the user can understand the position within the document of a region of the document displayed within the display window. The dimensions of the position marker are proportionate to the dimensions of the region displayed within the display window. Consequently, the context map in conjunction with the viewing position marker provide a visual context in which the size and location of the position marker relative to the context map indicate the relative position and size of the region of the document displayed within the display window.

The position marker is operable for movement within the display window the context map. For example, the marker is operable for movement from a first position within the context map to a second position within the context map. The display window is operable in response to such movement of the position marker to transition from a display of a first region of the document that corresponds to the first marker position within the context map to a second region of the document that corresponds to the second marker position within the context map.

A user can provide input to move the position marker by any number of mechanisms such as click of a mouse device, keypad commands or use of a finger/pointer on a touch screen, for example. The user provides input to move the position marker across the context map in order to change from a view of one region of the document to a view of a different region of the document. During a change from a display of one region of the document to the next, the position marker and the context map cooperate to orient the user as to the location within the document of the region of the document currently displayed within the display window.

The context map and the position marker have the visual appearance of being superimposed with at least a portion of a region of the document that is currently is displayed within the display window. In some embodiments, the map and the marker are superimposed with such portion such that the portion of the displayed region encompassed within the context map remains visible within the display window. The context map displayed may have a semi-transparent appearance. For example, an appearance of semi-transparency may be produced by displaying portions of a viewable region encompassed by the context map as having a different background color than other portions of the viewable region that are not encompassed by the map. Alternatively, the context map may be displayed as being transparent and as being demarcated as within a bounding box. An advantage of using a context map that does not fully obscure the portion of the region of the document that is in view is that a user can view the entire region despite the presence of the context map superimposed with a portion of it. This makes it easier for the user to decide whether she wishes to continue to display the region currently in view within the display window or to display a different region.

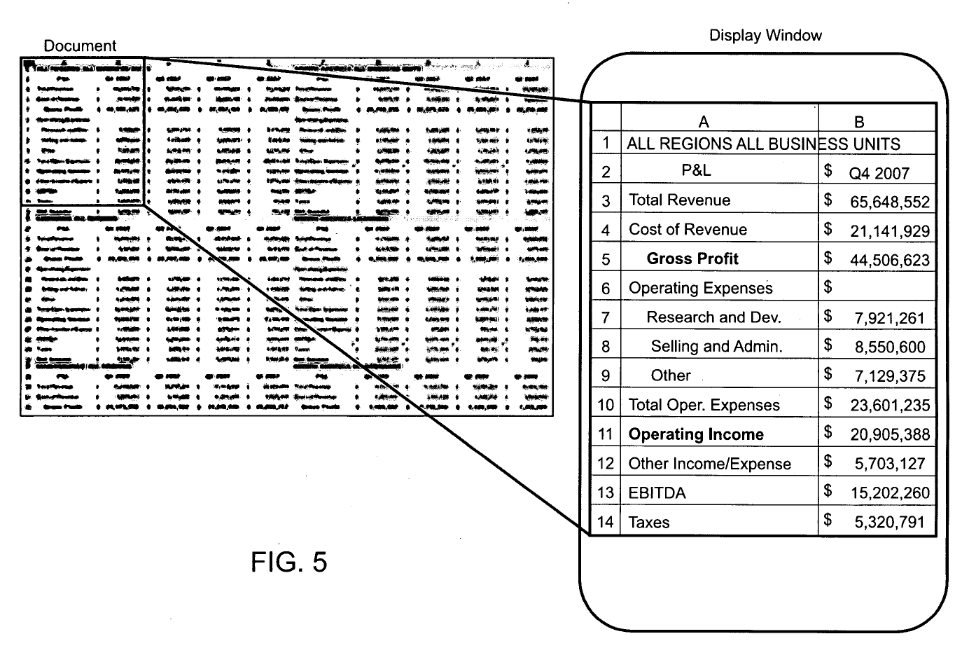

FIG. 5 is an illustrative drawing showing an entire document and showing a display window that displays a first region of the document in accordance with some embodiments of the invention. In this example, the document comprises a spreadsheet, which too large to display all at once within the device screen's display area. The drawing shows that only an upper/left corner of the document encompassing, column A, row 1 through column B, row 14 (A1:B14), displayed within the display window.

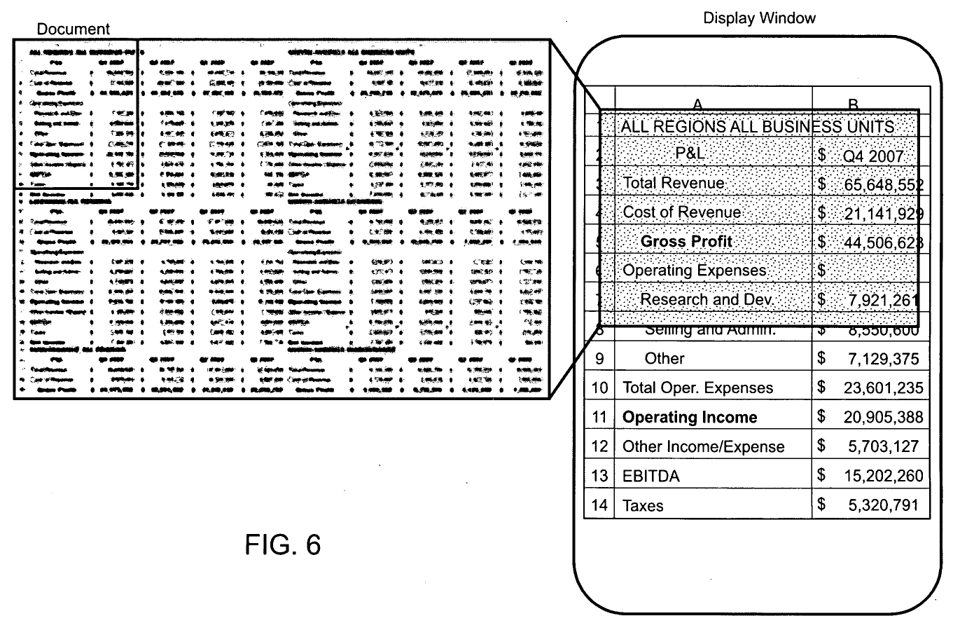

FIG. 6 is an illustrative drawing showing the document and display window of FIG. 5 and also showing a context map within the display window in accordance with some embodiments of the invention. The drawing shows that the context map displayed within the display window has dimensions that are proportionate to the dimensions of the overall document. The context map is represented as a highlighted area within the device display that is superimposed with a portion of the displayed region of the document. That region remains visible within the contours of the context map. The representation of the document in FIG. 6 is shown as highlighted to better indicate in this exemplary drawing that the context map highlighted within the display window corresponds to the entire document. The rectangular upper left region of the document is shaded differently from the rest of the document to indicate that it is this upper left document region that is displayed within the display window.

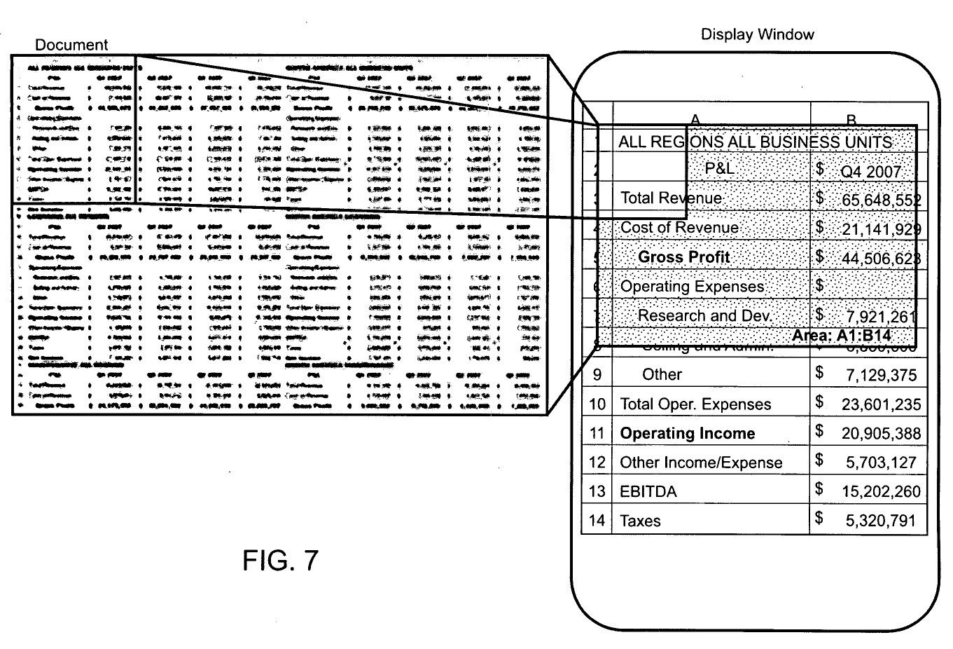

FIG. 7 is an illustrative drawing showing the document and display window and context map of FIG. 6 and also showing a viewing position marker within the context map in accordance with some embodiments of the invention. The drawing shows that the viewing position marker displayed within the context map has dimensions that are proportionate to the dimensions of the region of the document displayed within the display window. The drawing also shows that the position of the marker relative to the context map is the same as the position of the region displayed within the device display relative to the overall document. As such, the marker and the context map cooperate to inform the user of the relative location within the document of the region displayed within the display window. In other words, the context map puts the position marker in context so the user can understand the relative location of the displayed region within the document.

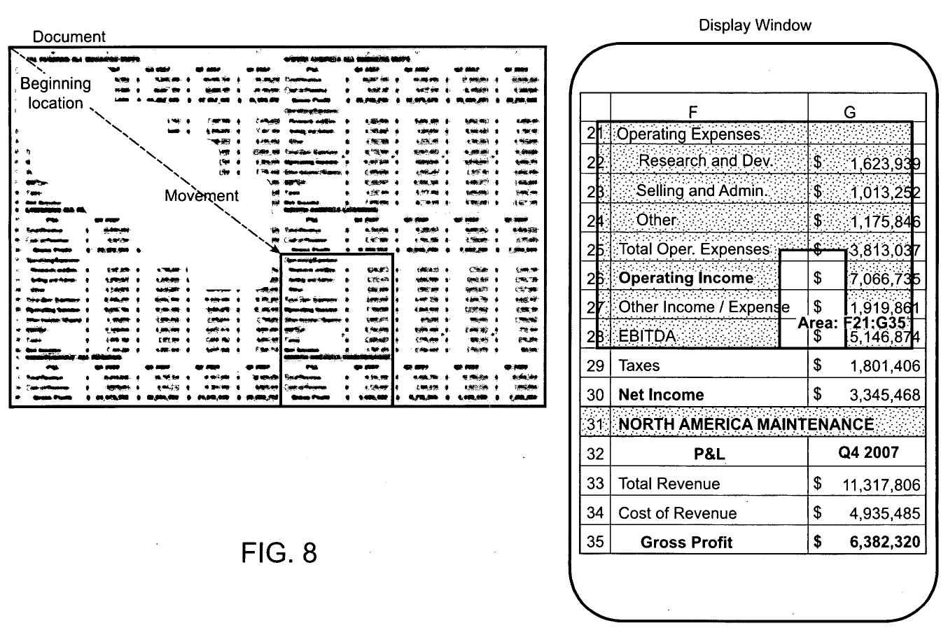

FIG. 8 is an illustrative drawing representing a transition from a display of a first region of the document of FIG. 7 within the device display to a display of a second region of the document within the device display in accordance with some embodiments of the invention. Intermediate regions of the document indicated within dashed lines are aligned along a path indicated by a dashed diagonal arrow. The diagonal arrow indicates a path through the document that corresponds to a path (not shown) through the context map followed by the position marker as it moves in response to user input from a first position relative to the context map to a second position relative to the context map.

In the course of movement of the position marker across the context map, a series of intermediate regions of the document may be displayed within the display window. These intermediate regions may be displayed only temporarily as the position marker scrolls across the context map. It will be appreciated that the display of the intermediate regions may be dependent upon factors such as the speed with which the user moves the position marker from the first position to the second position within the context map and the rate at which the display device can update the view within the display window. For example, a user may slowly move the position marker and pause periodically to view the intermediate regions. Alternatively, the user may move the position marker so rapidly across the context map that the display device has insufficient time to display intermediate regions. Moreover, the user may have no definite second region in mind as she moves the position marker within the context map, and may simply be browsing from one region to another within the document such that the ‘second’ region may be considered to be whatever region corresponds to the context map position at which the user pauses the position marker.

The display window of FIG. 8 shows the position marker disposed at the second position within the context map. The second position has a relative location within the context map that is the same as the relative location of the second region within the document. Moreover, in some embodiments, the display window provides coordinates representing the location of the displayed region within the overall document. In this example, the coordinates F21:G35 are displayed on the context map adjacent the position marker.

Alternatively, a in some embodiments, a user can change the location of a region of a document shown within the display window by inputting coordinates of the region to an address location input field on the display window. For example, the user could select a region of a spreadsheet document identified as F21 through entry of that coordinate into a search input field at the bottom of the display window. The location of the position marker within the context map would change automatically to indicate the new region displayed in response to input of those coordinates. Following the change, the display window shows the new region with the selected coordinate F21 in the upper left corner of the display window.

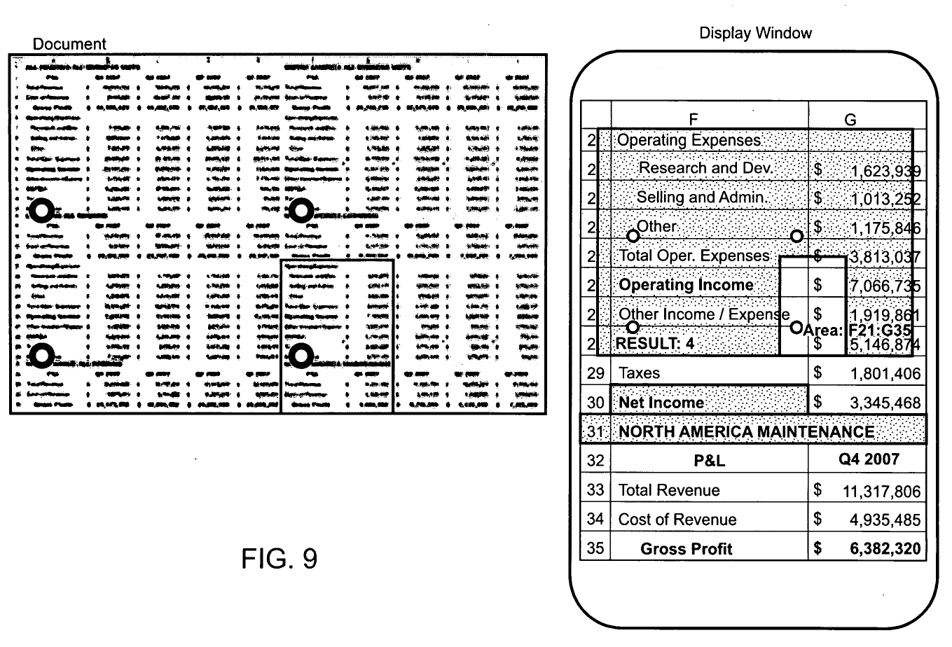

FIG. 9 is an illustrative drawing showing the document, display window, context map and marker of FIG. 8 and also showing search request match locations within the context map in accordance with some embodiments of the invention. The display device includes a search request field for entry of a text based search request. In this example, the user has entered the words, “Net income” in the search request field. In response, the device displays markers on the context map that correspond to locations within the document at which information responsive to the search request is located. In this example, the document includes multiple matches to the search request.

The illustration of the entire document shown in highlighted form in FIG. 9 includes match markers at relative locations in the document that are substantially the same as the relative location of the match markers displayed on the context map within the display window. A review of the document shows that the match markers are positioned in the document at the location of terms, i.e. the words, “net income”, that match the search request. Thus, the match markers on the context map indicate to a user where in the document the search results information can be viewed. The user can move the position marker to the match locations in order to view the search results information within the document regions indicated by the match markers.

The device display of FIG. 9 shows that the second region, F21:G35 in this example, includes a search request match. This match is represented by the appearance of a match marker within the position marker and also by the highlighting of the matching terms within the displayed second region, which is on display within the device display. The relative location of the match marker within the position marker is the same as the relative location of the highlighted search results within the second region.

Although the above illustrated example involves a search for a matching text string, the principles of the invention are applicable to more complex search queries such as numeric, special characters and document coordinates, for example.

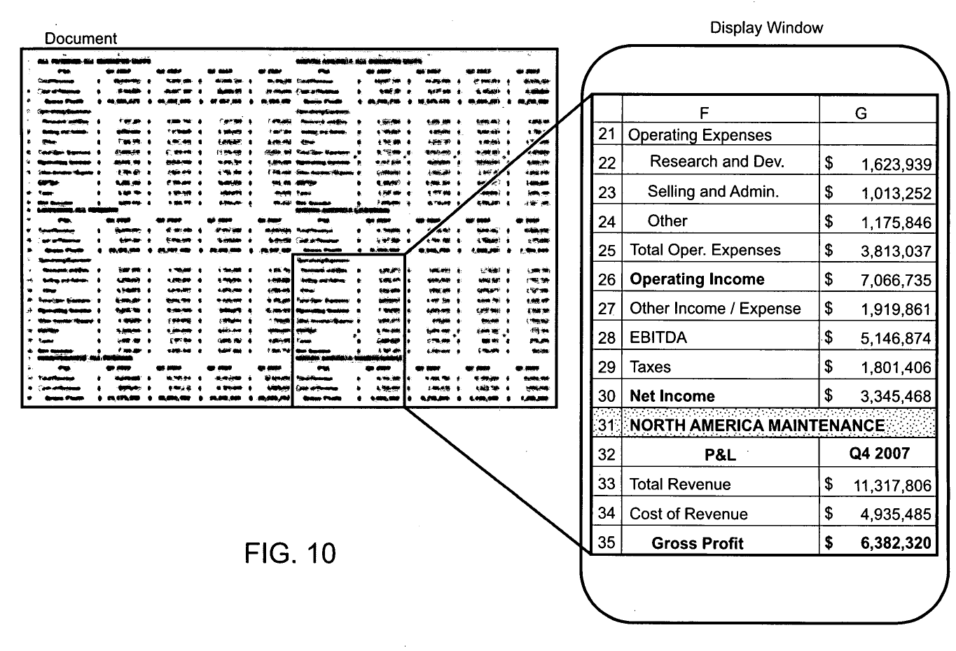

FIG. 10 is an illustrative drawing showing the document and the display window displaying the same second region that is shown in FIG. 9, but without the context map and position marker. A user may turn off or disengage display of the context map so as to view a selected region of the document without distraction from the context map and position marker. The drawing shows that the region currently in view corresponds to the second region of the document described above.

Thus, it will be understood that the context map and position marker can be used to search a document for a region to be displayed. Once that region has been located, the user optionally can turn off the display of the map and marker. If the user wishes to search of another region within the document, the user can turn on the map and marker and conduct another search or browse about until she locates another region of interest.

The use of a context map and position marker superimposed with whatever region of the document happens to be in view advantageously permits an intuitive method of document search using limited screen area. Specifically, the superimposing of a document region with the context map effects a combination of a search tool (i.e., context map plus position marker) within the display area without sacrificing the full display of the region of the document currently in view. Therefore, a user can simultaneously view the full document region currently selected for viewing to decide if this is where she wants to be within the document, while also viewing the superimposed context map from which she can discern where she may want to go next within the document.

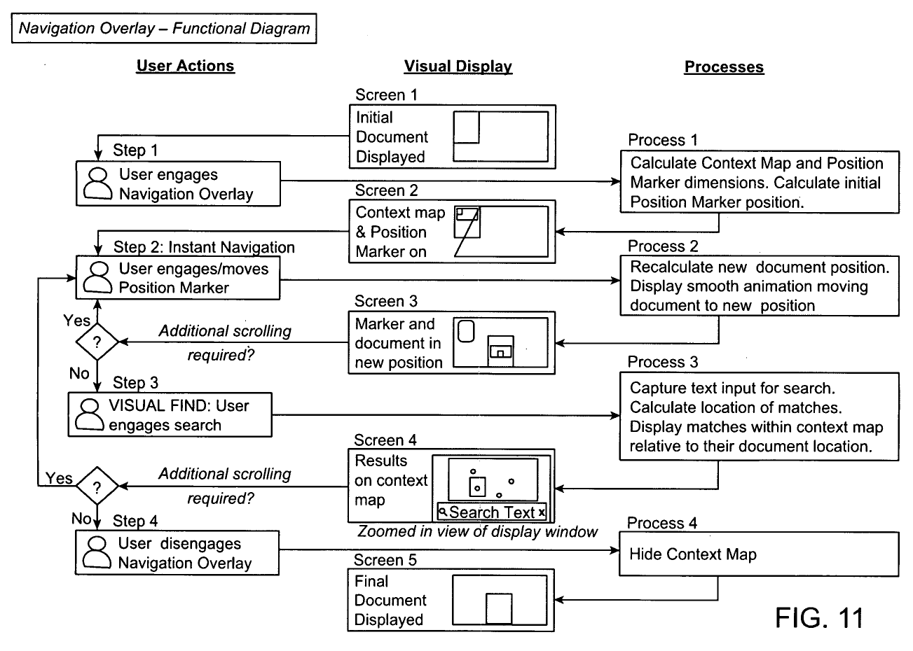

FIG. 11 is an illustrative flow diagram of a process to navigate through a document in accordance with some embodiments of the invention. The flow diagram shows user actions, corresponding device processes and corresponding device display windows. The user actions involve user input using device interface mechanisms such as, but not limited to, a click of a mouse device, keypad commands or use of a finger/pointer on a touch screen, for example. The device processes are performed by the device under control of one or more computer program processes or modules encoded in computer readable media. Similarly, the device display windows are generated under control of one or more computer program processes or modules encoded in computer readable media.

Screen 1 represents an initial display within the display window. In this example, the initial display also is represented by the illustrative drawing of FIG. 5. The display window shows a first region of the document, which is disposed in an upper/left corner of the document, e.g., location A1:B14 of the spreadsheet example.

In user action step 1, the user enters an input command to engage (turn on) the navigation overlay. In response to the user action, process 1, which may be implemented through computer program instructions or a software module encoded in computer readable memory, calculates a context map area and position marker dimensions and determines an initial position marker position within the map. Process 1 also causes the screen context map and position marker to be superimposed within the display window as indicated by screen 2. The addition of the overlay and position marker to the initial display also is represented by the illustrative drawing of FIG. 7.

In user action step 2, a device user provides input to command the position marker to transition from a first position within the context map (i.e., from the position shown in screen 2/FIG. 7) to a second position within the context map. In response, a process 2, which may be implemented through computer program instructions or a software module encoded in computer readable memory, calculates a location of a second region relative to the document that is substantially the same as the second position of the position marker relative to the context map. The process 2 also causes a display of a smooth animation of the movement through the document from the first region to the second region as indicated by the visual display block screen 3. As explained above, the transition can be shown as a smooth transition provided that the user dose not move the marker too rapidly. In a smooth animation, one or more intermediate regions of the document may be displayed on a path between the first and second document regions. The transition of the display from the first to the second region also is represented by the illustrative drawing of FIG. 8.

In user action step 3, a device user enters a search request into a search field provided by the device display. In response, a process 3, which may be implemented through computer program instructions or a software module encoded in computer readable memory, captures the search request input and searches for matches within the document. The process 3 calculates the locations of information within the document that matches the search request. The process 3 causes a display of match markers within the context map that indicate locations of information in the document that matches the search request as indicated by the visual display block screen 4. The display of match markers also is represented by the illustrative drawing of FIG. 9.

In user action step 4, a device user disengages the context map. In response, process 4, which may be implemented through computer program instructions or a software module encoded in computer readable memory, causes the removal of the context map and position marker from the display window as indicated by the visual display block screen 5. The removal of the context map and position marker also is represented by the illustrative drawing of FIG. 10.

The following sections describe processes in accordance with some embodiments of the invention to generate and display a context map and a position marker in accordance with some embodiments of the invention.

Definitions used in calculations involving the disclosed embodiment:

### Variables:

Known
widthod Width of the original document (Provided in a document source file)
heightod Height of the original document (Provided in document source file)
widthw Width of the Display Window
heightw Height of the Display Window
Calculated
widthd Width of the Document based on the Percent View of the data in the Display Window
heightd Height of the Document based on the Percent View of the data in the Display Window
widthcm Width of the Context Map
heightcm Height of the Context Map
R Conversation Ratio
widthpm Width of the Position Marker
heightpm Height of the Position Marker
Xd X-coordinate on the Document of the upper, left data point displayed on the Display Window
Yd Y-coordinate on the Document of the upper, left data point displayed on the Display Window
Xcm X-coordinate on the Context Map of the upper, left corner of the Position Marker
Ycm Y-coordinate on the Context Map of the upper, left corner of the Position Marker
Xsd X-coordinate (width location) of search result on the Document
Ysd Y-coordinate (height location) of search result on the Document
Xscm X-coordinate (width location) of search result on the Context Map
Yscm Y-coordinate (width location) of search result on the Context Map

### Process 1—Calculation of Document Size

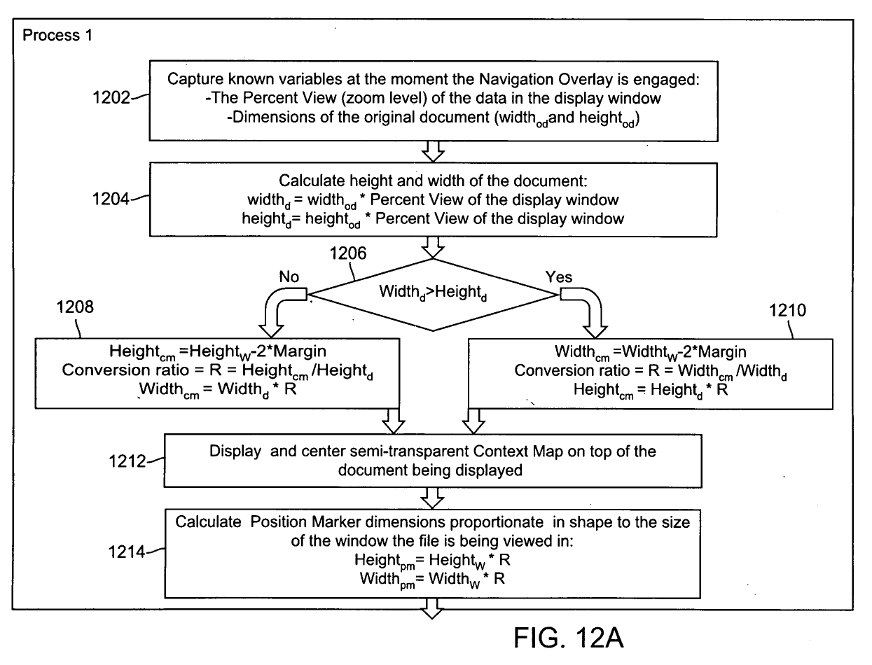

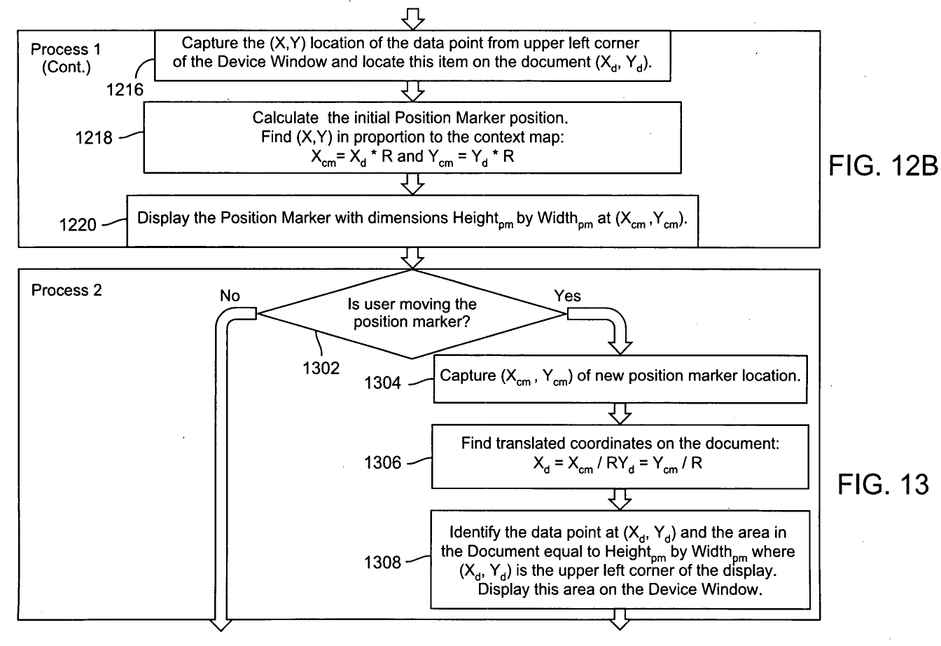

FIGS. 12A-12B show an illustrative flow diagram representing process 1 of FIG. 11 in accordance with some embodiments of the invention. Documents are translated into a document source file, e.g., an XML file, in which the dimensions of the original document (heightod and widthod) are stored. Then, the document height and width of the document can be calculated based on the size of the view in the display window.

widthd=widthod*Percent View of the display window

heightd=heightod*Percent View of the display window

The area (size/amount) of data displayed in the display window depends on the level of zoom the user was viewing prior to engaging the context map.

Process 1 is a computer program process that determines dimensions and positions of the context map and position map within a display window. The blocks in the flow diagram of FIGS. 12A-12B represent computer program processes or modules within the overall process 1. Block 1202 captures the percent or proportion of the document of the document viewable in the display window at the moment that the context map is engaged and the dimensions of the original document widthod and heightod. Block 1204 calculates the height and width of the document based upon the proportion of the document displayed within the display window. Decision block 1206 determines whether the width or the height of the document is larger. If decision step 1206 determines that document height is larger than its width, then block 1208 computes context map height based upon height of the display window; calculates a conversion ratio based upon the computed context map height; and computes context map width based upon the computed conversion ratio. If on the other hand, decision step 1206 determines that document width is larger than its height, then block 1210 computes context map width based upon width of the display window; calculates a conversion factor based upon the computed context map width; and computes context map height based upon the computed conversion factor. Block 1212 causes the context map to be superimposed upon and centered with a region of the document shown within the display window. Block 1214 calculates position marker dimensions based upon the window dimensions and the conversion factor. Block 1216 captures an (Xd, Yd) position relative to the document of a prescribed location within the region of the document viewable within the display window. In some embodiments, the prescribed (Xd, Yd) position is the uppermost left corner of the region. Block 1218 computes an (Xcm, Ycm) position within the context map that has substantially the same position relative to the context map that the prescribed position has relative to the document. Block 1220 displays an uppermost left corner of the position marker within the context map at the calculated (Xcm, Ycm) position within the context map that corresponds to the prescribed (Xd, Yd) position within the document.

FIG. 13 is an illustrative flow diagram representing process 2 of FIG. 11 in accordance with some embodiments of the invention. Process 2 is a computer program controlled process that runs once the context map and position marker have been displayed according to process 1 of FIGS. 12A-12B. Decision step 1302 determines whether the user has provided an input to cause movement of the position marker within the context map. If the user has provided input to cause the position marker to move, then block 1304 captures the new (Xcm, Ycm) position, i.e., in this example, the new location of the uppermost left corner of the position marker relative to the context map. Block 1306 determines the corresponding new coordinates of the document that correspond to the translated position of the uppermost left portion of the position marker. Block 1308 determines a corresponding new region of the document to show within the display such that an uppermost left corner of the new document region has a position relative to the overall document that is the substantially the same as the new position of the uppermost left region of the position marker relative to the overall context map. Process 3 runs when the decision step 1402 receives input from the user to engage visual find.

It will be appreciated that a user may provide input to move the position marker diagonally across the context map. Process 2, as illustrated in FIG. 13, causes display of regions of the document that correspond locations of the position marker as users causes it to traverse the context map. Thus, process 2 permits traversal diagonally across a large spreadsheet document (or other document) rather than requiring scrolling in horizontal and vertical directions.

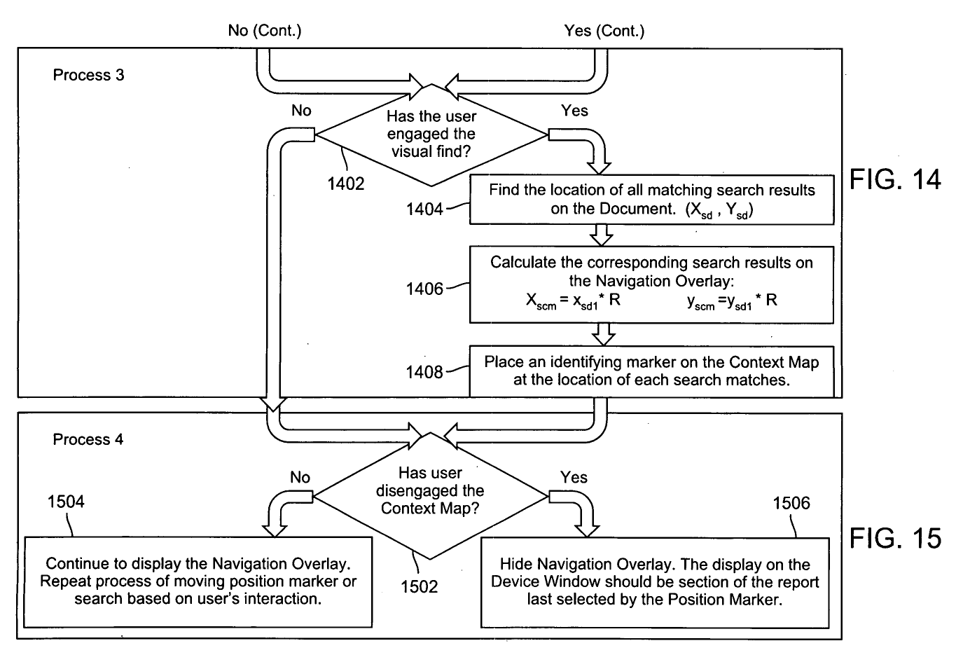

FIG. 14 is an illustrative flow diagram representing process 3 of FIG. 11 in accordance with some embodiments of the invention. Process 3 is a computer program controlled process. Block 1402 determines whether the user has provided input to indicate search criteria. If the user provides input indicating search criteria, then block 1404 conducts a search of the document for matching search results. Block 1406 determines locations within the context map that correspond to locations of search results within the document. Block 1408 generates match markers within the context map at positions relative to the overall context map that are substantially the same as positions of corresponding search results within the document relative to the overall document. Process 4 runs when blocks 1404-1408 have determined the match marker locations, or in the event that decision step 1402 determines that there has been no user input of search criteria.

FIG. 15 is an illustrative flow diagram representing process 4 of FIG. 11 in accordance with some embodiments of the invention. Process 4 is a computer program controlled process. Decision block 1502 determines whether the user has provided input to cause the context map to become disengaged, i.e., to turn off the context map. If decision block 1502 determines that no disengagement command has been received, then block 1504 causes the context map and position marker to continue to be displayed and returns to the start of process 1 such that processes 1-4 repeat. If on the other hand, decision block 1502 determines that a disengagement command has been received, then block 1506 causes the context map and position marker to disappear. Block 1506 also causes display of a region of the document that has a position relative to the document that corresponds to the last displayed position of the position marker relative to the context map.

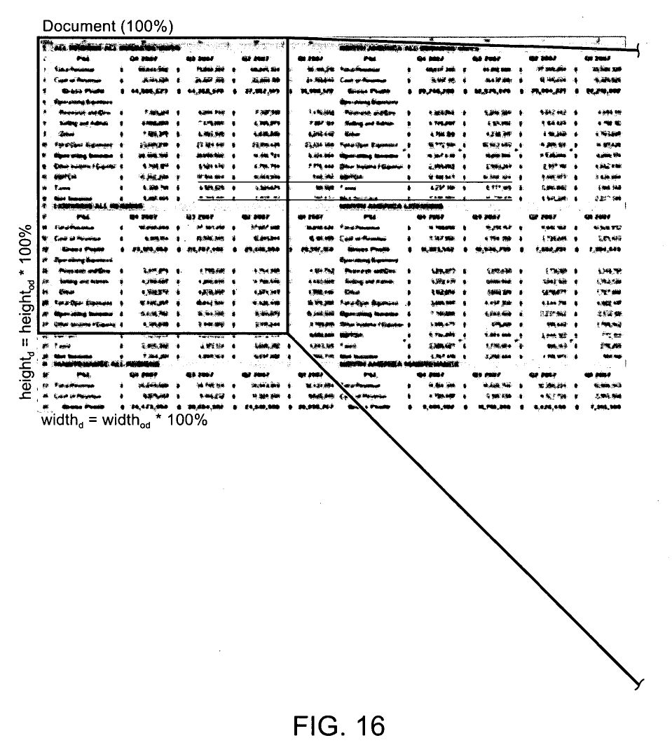

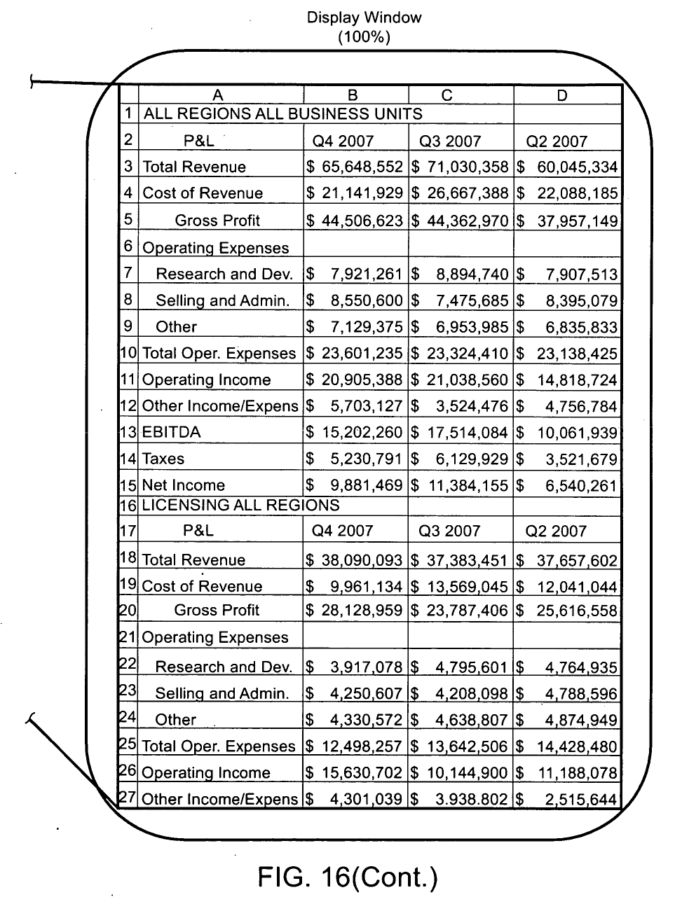

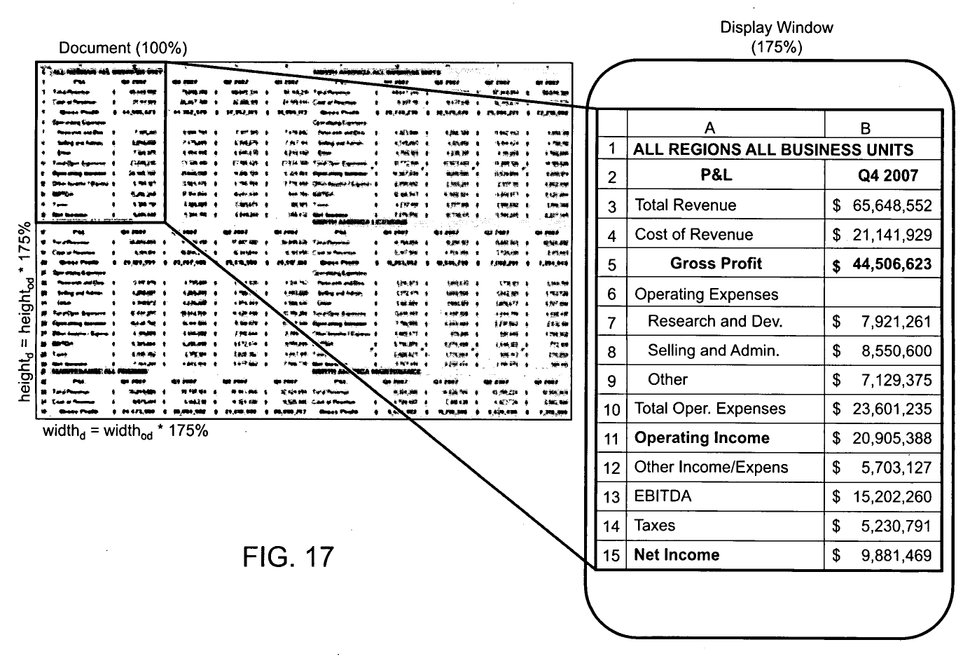

FIG. 16 is an illustrative drawing displaying 100% zoom level for the original document. FIG. 17 is an illustrative drawing displaying 175% zoom level for the original document. This zoom level may be pre-determined or set by the end-user using known methods of zooming in and out. The zoom level is a metric collected by the by process 1 to ensure the correct proportions are represented.

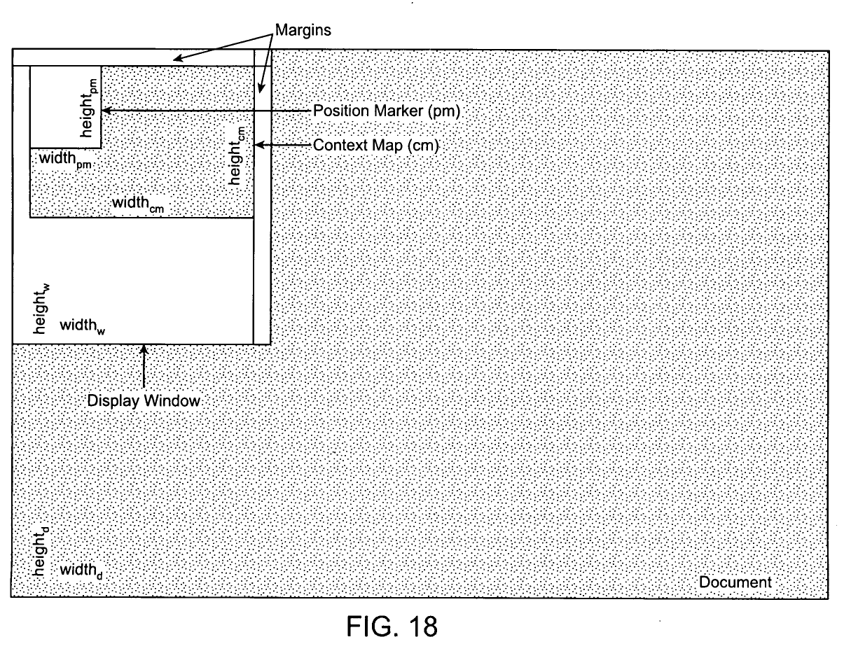

FIG. 18 is an illustrative drawing showing dimensions of document, display window, context map and position marker used by process 1 to determine context map area and position marker area in accordance with some embodiments of the invention.

### Context Map Area Calculations:

heightd/widthd=heightcm/widthcm

If widthd is greater than heightd, then calculate ratio of width first, where widthna is at the maximum.

widthcm=widthw−2*margin

Find conversion ratio to scale dimensions:

widthcm/widthd=R

Now, solve for heightcm

heightcm=heightd*R

If not, then calculate ratio of height first, where heightcm is at the maximum.

heightcm=heightw−2*margin

Find conversion ratio:

heightcm/heightd=R

Now solve for widthcm

widthcm=widthd*R

### Position Marker Calculations:

Position marker should be proportionate in shape and size to the display window.

heightpm=heightw*R

widthpm=widthw*R

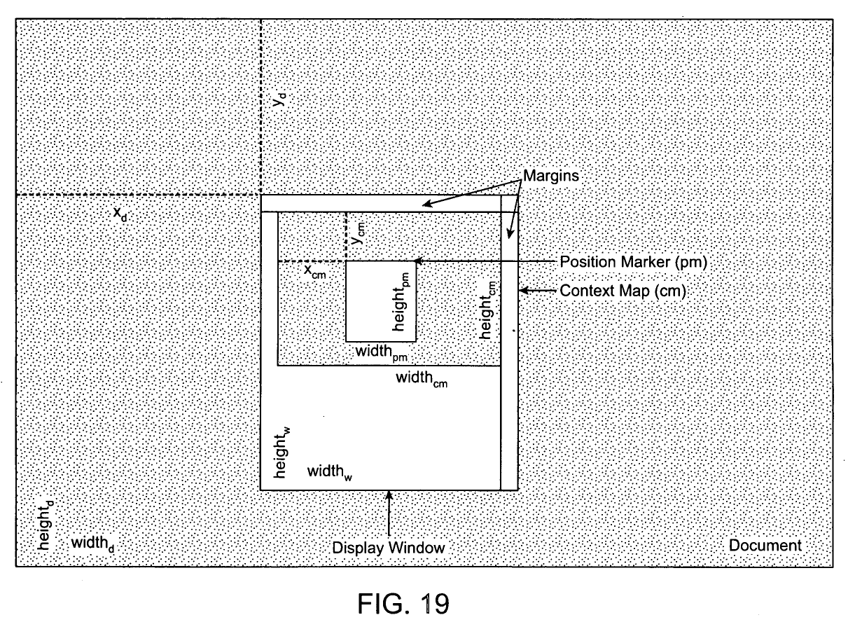

FIG. 19 is an illustrative drawing showing dimensions of document, display window, context map and position marker used by process 1 to determine initial document position in accordance with some embodiments of the invention. Position calculation is based on the relative position from the upper, left corner, which serves as a reference location. Similar to an x-y coordinate system, the upper, left corner reference location would be (0, 0). The relative position of the position marker within the context map can be calculated using the location on the document and the conversion ratio to scale dimensions calculated above in process 1. For the initial position, identify the data point in the upper left corner of the display window. Find the coordinates of that same data point on the Document (Xd, Yd). Then, convert these document coordinates to content map coordinates.

Xcm=Xd*R

Ycm=Yd*R

Display the position marker on the context map so the position marker's upper left corner is (Xcm, Ycm).

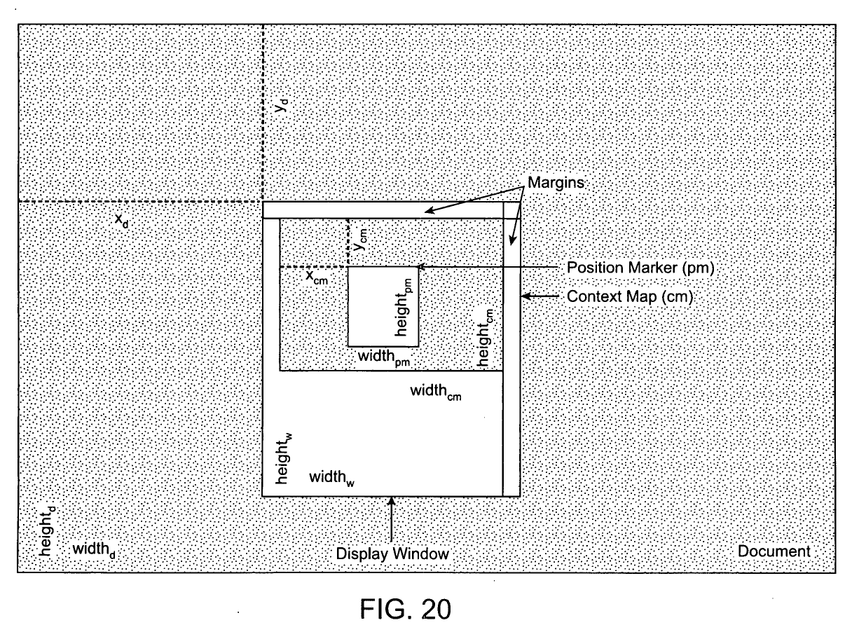

FIG. 20 is an illustrative drawing showing width and dimensions of document, display window, context map and position marker used by process 2 in the course of movement of the position marker to a different (second) position and the transition of the display window to a different (second) region. Position calculation is based on the relative position from the upper, upper/left corner. Similar to an x-y coordinate system, the upper, left corner would be (0, 0). The relative position of the position marker can be calculated using the location on the document and the conversion ratio calculated in process 1. Capture (Xcm, Ycm) of new position marker location. Find translated coordinates on the document:

Xd=Xcm/R

Yd=Ycm/R

Identify the data point at (Xd, Yd) and the corresponding area in the document equal to Heightpm by Widthpm where (Xd, Yd) is the upper left corner of the display. Display this data area on the display window. Display the position marker within the context map so as to have an upper left corner at (Xcm, Ycm).

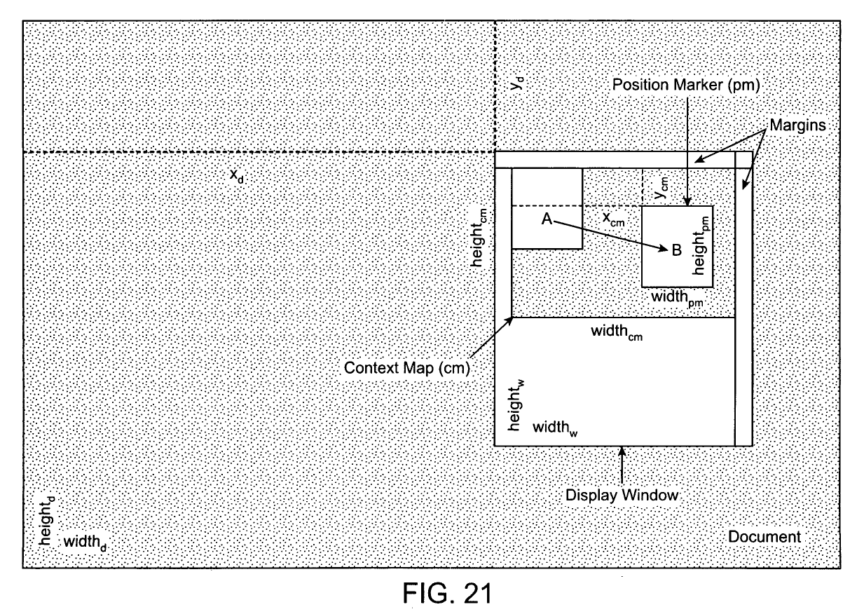

FIG. 21 is an illustrative drawing representing position marker transition in a smooth animation along a path from a first position “A” to a second position “B” within the context map using process 2 in accordance with some embodiments of the invention. Overall navigation of the display window is controlled by measuring the relative location of the position marker in proportion to the entire document and the display window. When the device user moves the position marker from location A to location B within the context map, the process 2 program will capture the location of B with the (x, y) coordinates on the context map. Therefore, Xcm and Ycm are known. By calculating the same proportion on the document, Xd and Yd the process 2 program can be used to identify the region of the document to be displayed within the display window. Performing this calculation in real-time can allow a smooth animation of the traversal across the document from a document region corresponding to context map location A to a document region corresponding to context map location B.

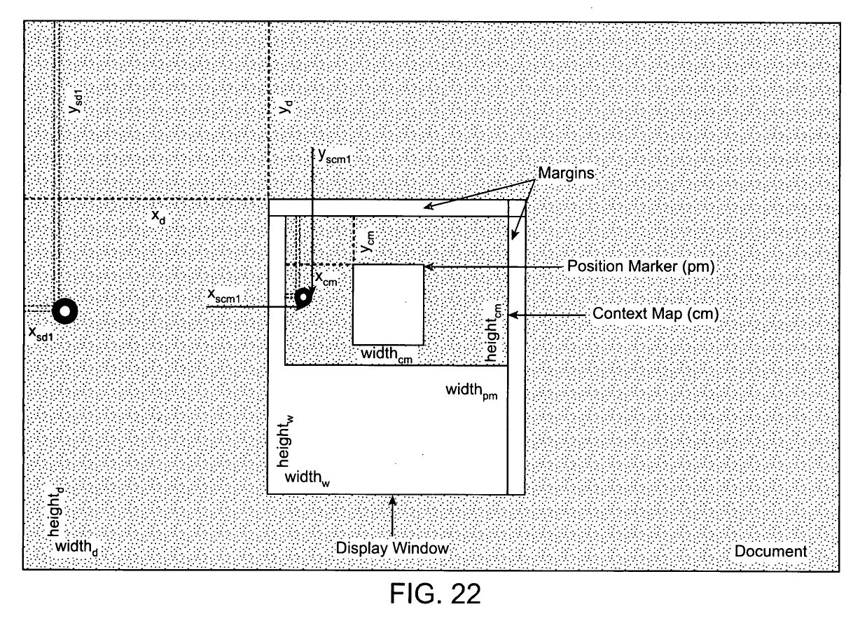

FIG. 22 is an illustrative drawing representing identification and display of match markers in response to a user search request using process 3 in accordance with some embodiments of the invention. Position calculation is based on the relative position from a reference location at the the upper, left corner. Similar to an x-y coordinate system, the upper, left corner would be (0, 0). In some embodiments, search result locations in the document are provided via XML. Those search result locations can then be correlated to positions within the context map with through scaling of dimensions using the conversion ration “R” calculated using process 1.

xsd1=Width location of search result 1 on the document.

ysd1=Height location of search result 1 on the document.

Location on the context map:

Xscm1=xsd1*R

Yscm1=ysd1*R

This process is repeated for all additional search matches. As shown in FIG. 9, the number of search matches are displayed in lower left corner of the context map.

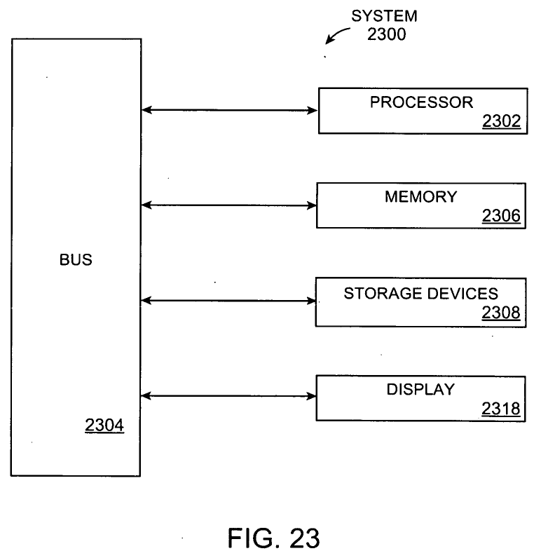

FIG. 23 is an illustrative block level diagram of a processing system 2300 that can be programmed to implement processes involved with navigating a document in accordance with embodiments of the invention. Processing system 2300 may be embodied in any number of different devices such as a personal computer, tablet computer, smart mobile device or mobile phone, for example. Processing system 2300 can include one or more processors, such as a processor 2302. Processor 2300 can be implemented using a general or special purpose processing engine such as, for example, a microprocessor, controller or other control logic. In the example illustrated in FIG. 23, processor 2302 is connected to a communication channel, i.e., bus 2304 or other communication medium.

Processing system 2300 also can include a main memory 2306, preferably random access memory (RAM) or other dynamic memory, for storing information and instructions to be executed by processor 2302. Main memory 2306 also may be used for storing temporary variables or other intermediate information during execution of instructions to be executed by processor 2302. Processing system 2300 can likewise include a additional storage devices such as read only memory (“ROM”), a hard disk, a floppy disk, magnetic tape, optical disk, a CD or DVD, Flash storage or other fixed or removable medium to store static information and instructions for processor 2302. The main memory 2306 and the storage devices 2308 may store data such as a document including document source information, for example. The main memory 2306 and the storage devices 2308 may store instructions such as instructions for program controlled processes 1-4. The main memory 2306 and the storage devices 2308 also may store instructions to generate the display of the document regions, context map and position marker and match markers within a display window.

The processing system 2300 also includes a display unit 2318 that can be used to produce a display window in which to display document regions superimposed with a context map and including a position marker. The display unit 2318 can be used to display match markers within the context map that are associated with one or search results.

In this specification, the terms “computer program medium” and “computer useable medium” are used to generally refer to media such as, for example, memory 2306, storage device 2308, a hard disk installed in hard disk drive 2310. These and other various forms of computer useable media may be involved in carrying one or more sequences of one or more instructions to processor 2302 for execution. Such instructions, generally referred to as “computer program code” (which may be grouped in the form of computer programs or other groupings), when executed, enable the processing system 2300 to perform features or functions of the present invention as discussed herein.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

1. A visual interface method to select a region of a document for display in an electronic device display window comprising:
displaying within the display window a first region of the document;
displaying within the display window a context map superimposed with at least a portion of the first region;
wherein the context map has dimensions that are substantially proportionate to dimensions of the document;
displaying within the display window within the context map a position marker at a first position relative to the context map;
wherein the first region of the document is disposed at a first position relative to the document that is substantially the same as the first position of the position marker relative to the context map;
displaying within the display window a change in position of the position marker to a second position relative to the context map; and
displaying within the display window in response to such change of the position marker to the second relative position, a second region of the document that is disposed at a second position relative to the document that is substantially the same as the second position of the position marker relative to the context map.

2. The method of claim 1,
wherein the position marker has dimensions that are substantially proportionate to dimensions of the region of the document displayed within the display window.

3. The method of claim 1,
wherein the context map is superimposed with the portion of the region displayed within the display window such that such portion is visible to a user.

4. The method of claim 1 further including:
determining the first and second positions relative to the document based upon coordinates of at least one reference location within the document; and
determining the first and second positions relative to the context map based upon coordinates of at least one reference location within the context map.

5. The method of claim 1 further including:
determining dimensions of the context map that are substantially proportionate to dimensions of the document and that are scaled such that the context map fits within the display window.

6. The method of claim 1 further including:
determining dimensions of the context map that are substantially proportionate to dimensions of the document and that are scaled such that the context map fits within the display window;
determining the first and second positions relative to the document based upon the document dimensions and coordinates of at least one reference location within the document; and
determining the first and second positions relative to the context map based upon the context map dimensions and coordinates of at least one reference location within the context map.

7. The method of claim 1,
wherein the document is stored as a file that includes document dimension information.

8. The method of claim 1,
wherein the document is stored as an XML file that includes document dimension information; and further including:
determining document dimensions based upon the XML information.

9. The method of claim 1,
wherein the document is stored as a file that includes document dimension information; and
wherein the device provides a display zoom level.; and further including:
determining document dimensions based upon the document dimension information and the provided zoom level.

10. The method of claim 1,
wherein the position marker has dimensions that are substantially proportionate to dimensions of the region of the document displayed within the display window; and further including:
determining dimensions of the context map that are substantially proportionate to dimensions of the document and that are scaled such that the context map fits substantially within the display window; and
determining dimensions of the position marker that are substantially proportionate to dimensions of a region of the document displayed within the device display and that are scaled relative to such region by substantially the same amount that the context map is scaled relative to the document.

11. The method of claim 1,
wherein the position marker is operable in response to user input to change to a second position relative to the context map; and further including:
receiving user input to the device to change the position of the position marker;
wherein the step of displaying within the display window a change in position of the position marker to a second position relative to the context map occurs in response to user input.

12. The method of claim 1 further including:
receiving user input to the device to indicate a search request for information within the document;
displaying within the display window within the context map match markers that correspond to positions within the document that include information responsive to the search request;
wherein each respective match marker is disposed at a position relative to the context map that is substantially the same as a respective corresponding position relative to the document at which information responsive to the search request is located within the document.

13. The method of claim 1 further including:
receiving user input to the device to indicate a search request for information within the document;
displaying within the display window within the context map match markers that correspond to positions within the document that include information responsive to the search request;
wherein each respective match marker is disposed at a position relative to the context map that is substantially the same as a respective corresponding position relative to the document at which information responsive to the search request is located within the document; and
displaying within the display window a change in position of the position marker to a third position relative to the context map at which a match marker is displayed.

14. The method of claim 1 further including:
receiving user input to the device to indicate a search request for information within the document;
displaying within the display window within the context map match markers that correspond to positions within the document that include information responsive to the search request;
wherein each respective match marker is disposed at a position relative to the context map that is substantially the same as a respective corresponding position relative to the document at which information responsive to the search request is located within the document; and
displaying within the display window a change in position of the position marker to a third position relative to the context map at which a match marker is displayed; and
displaying with emphasis the information within the third region that is responsive to the search request.

15. The method of claim 1,
wherein displaying within the display window a change in position of the position marker to a second position relative to the context map involves displaying motion of the position marker along a path between the first and second positions within the context map.

16. The method of claim 1,
wherein displaying within the display window the change in position of the position marker to a second position relative to the context map involves displaying motion of the position marker along a path between the first and second positions within the context map; and further including:
displaying within the display window during changing of position of the position marker, an intermediate region of the document that is disposed at an intermediate position relative to the document that is substantially the same as an intermediate position along the path relative to the context map.

17. The method of claim 1,
wherein displaying within the display window a change in position of the position marker to a second position relative to the context map involves displaying motion of the position marker along a substantially diagonal path between the first and second positions within the context map.

18. The method of claim 1 further including:
removing the context map from display.

19. The method of claim 1 further including:
receiving user input to remove the context map from the display; and
removing the context map from display in response to the user input.

20. A visual interface method to select a region of a document for display in an electronic device display window comprising:
displaying within the display window a first region of the document;
displaying within the display window a context map superimposed with at least a portion of the first region;
wherein the context map has dimensions that are substantially proportionate to dimensions of the document;
displaying within the display window within the context map a position marker at a first position relative to the context map;
wherein the first region of the document is disposed at a first position relative to the document that is substantially the same as the first position of the position marker relative to the context map;
receiving user input to the device to indicate a search request for information within the document;
displaying within the display window within the context map match markers that correspond to positions within the document that include information responsive to the search request;
wherein each respective match marker is disposed at a position relative to the context map that is substantially the same as a respective corresponding position relative to the document at which information responsive to the search request is located within the document; and
displaying within the display window a change in position of the position marker to a second position relative to the context map at which a match marker is displayed; and
displaying within the display window in response to such change of the position marker to the second relative position, a second region of the document that is disposed at a second position relative to the document that is substantially the same as the second position of the position marker relative to the context map.

21. The method of claim 20 further including:
displaying with emphasis the information within the third region that is responsive to the search request.

22. The method of claim 20,
wherein the position marker is operable in response to user input to change to a second position relative to the context map; and further including:
receiving user input to the device to change the position of the position marker;
wherein the step of displaying within the display window a change in position of the position marker to a second position relative to the context map occurs in response to user input.

23. A user interface system to select a region of a document for display in an electronic device display window comprising:
a context map displayed within the display window superimposed with at least a portion of a first region of the document is displayed within the display window;
wherein the context map has dimensions that are substantially proportionate to dimensions of the document;
a user operable position marker displayed within the display window within the context map at the first position relative to the context map;
a first process encoded in computer readable media to cause the device to be responsive to a user input to change a position of the position marker displayed within the display window within the context map from the first position relative to the context map to a second position relative to the context map and to cause the device to change from a display of a first region of the document having a first position relative to the document to a display of a second region of the document having a second position relative to the document;
wherein the first position relative to the context map is substantially the same as the first position relative to the document; and
wherein the second position relative to the context map is substantially the same as the second position relative to the document.

24. The method of claim 23,
wherein the position marker has dimensions that are substantially proportionate to dimensions of the region of the document displayed within the display window.

25. The method of claim 23,
wherein the context map is superimposed with the portion of the region displayed within the display window such that such portion is visible to a user.

26. The method of claim 23,
wherein the first process,
causes the device to determine the first and second positions relative to the document based upon coordinates of at least one reference location within the document; and
causes the device to determine the first and second positions relative to the context map based upon coordinates of at least one reference location within the context map.

27. The method of claim 23,
wherein the first process,
causes the device to determine dimensions of the context map that are substantially proportionate to dimensions of the document and that are scaled such that the context map fits within the display window.

28. The method of claim 23,
wherein the first process,
causes the device to determine dimensions of the context map that are substantially proportionate to dimensions of the document and that are scaled such that the context map fits within the display window;
causes the device to determine the first and second positions relative to the document based upon the document dimensions and coordinates of at least one reference location within the document; and
causes the device to determine the first and second positions relative to the context map based upon the context map dimensions and coordinates of at least one reference location within the context map.

29. The method of claim 23,
wherein the position marker has dimensions that are substantially proportionate to dimensions of the region of the document displayed within the display window; and
wherein the first module causes,
causes the device to determine dimensions of the context map that are substantially proportionate to dimensions of the document and that are scaled such that the context map fits substantially within the display window; and
causes the device to determine dimensions of the position marker that are substantially proportionate to dimensions of a region of the document displayed within the device display and that are scaled relative to such region by substantially the same amount that the context map is scaled relative to the document.

30. The method of claim 23 further including:
a second process encoded in computer readable media to cause,
causes the device to display within the display window within the context map match markers that correspond to positions within the document that include information responsive to a user search request;
wherein each respective match marker is disposed at a position relative to the context map that is substantially the same as a respective corresponding position relative to the document at which information responsive to the search request is located within the document.

31. The method of claim 23 further including:
a third process encoded in computer readable media to cause the device to remove the context map from display.

32. An article of manufacture including a computer readable medium encoded with a process to cause an electronic device that includes a display screen to perform a process comprising:
displaying within the display window a first region of the document;
displaying within the display window a context map superimposed with at least a portion of the first region;
wherein the context map has dimensions that are substantially proportionate to dimensions of the document;
displaying within the display window within the context map a position marker at a first position relative to the context map;
wherein the first region of the document is disposed at a first position relative to the document that is substantially the same as the first position of the position marker relative to the context map;
displaying within the display window a change in position of the position marker to a second position relative to the context map; and
displaying within the display window in response to such change of the position marker to the second relative position, a second region of the document that is disposed at a second position relative to the document that is substantially the same as the second position of the position marker relative to the context map.
